(19) United States
(12) Patent Application Publication
(10) Pub. No.: US 2026/0361443 A1
(43) Pub. Date: Nov. 12, 2026

(54) Photonic transceiver with integrated waveguide amplifier

(71) Applicant: Marvell Asia Pte Ltd, Singapore (SG)

(72) Inventors: Masaki Kato, Palo Alto, CA (US); Aimin Xing, Irvine, CA (US); Louise Wang, Cupertino, CA (US)

(21) Appl. No.: 19/661,721

(22) Filed: Apr. 29, 2026

Related U.S. Application Data
(60) Provisional application No. 63/802,115, filed on May 8, 2025.

(51) Int. Cl. H04J 14/02; H04B 10/43

(52) U.S. Cl. CPC H04J 14/0307; H04B 10/43

(57) ABSTRACT

A photonic device includes a laser and a circuit. The laser is configured to emit light for optical excitation. The circuit, which is monolithically integrated on a substrate and is optically coupled to the laser, includes: (i) a waveguide doped with a rare-earth element, the waveguide configured to form a waveguide amplifier, and (ii) a wavelength division multiplexer (WDM) coupler configured to convey light from the laser into the waveguide doped with the rare-earth element. In response to receiving the light emitted from the laser, the waveguide is configured to optically excite the rare-earth element to provide optical gain to an optical signal conveyed into the circuit.

### CROSS-REFERENCE TO RELATED APPLICATIONS

This application claims the benefit of U.S. Provisional Patent Application 63/802,115, filed May 8, 2025, whose disclosure is incorporated herein by reference.

### FIELD OF THE DISCLOSURE

The present disclosure relates generally to photonic integrated circuits, and more particularly but not exclusively to silicon photonics transceivers with integrated waveguide amplifiers.

### BACKGROUND

Optical transceivers convert electrical signals to optical signals for transmission over optical fibers and convert received optical signals back to electrical signals. Optical amplification may be used in transceiver systems to compensate for optical losses and/or to boost signal strength. Various approaches to optical amplification exist, such as photonic transceivers with external amplifiers and semiconductor optical amplifiers (SOAs). However, external amplifiers and SOAs require additional expensive components and complex module assembly processes, and typically introduce between 1 dB and 3 dB fiber coupling loss that degrades transmitter launch optical signal-to-noise ratio (OSNR).

Therefore, it is important to develop techniques for integrating optical amplification into transceivers on the same substrate to improve performance, and utilize shared process integration for cost efficiency.

The description above is presented as a general overview of related art in this field and should not be construed as an admission that any of the information it contains constitutes prior art against the present patent application.

### SUMMARY

An embodiment of the present invention that is described herein provides a photonic device, including a laser and a circuit. The laser is configured to emit light for optical excitation. The circuit, which is monolithically integrated on a substrate and is optically coupled to the laser, includes: (i) a waveguide doped with a rare-earth element, the waveguide configured to form a waveguide amplifier, and (ii) a wavelength division multiplexer (WDM) coupler configured to convey light from the laser into the waveguide doped with the rare-earth element. In response to receiving the light emitted from the laser, the waveguide is configured to optically excite the rare-earth element to provide optical gain to an optical signal conveyed into the circuit.

In some embodiments, the rare-earth element includes erbium or praseodymium. In other embodiments, the substrate includes a silicon substrate, and the circuit further includes a silicon waveguide and a modulator coupled to the silicon waveguide, the modulator being configured to modulate the optical signal from a continuous wave laser input to form a modulated optical signal, and the waveguide doped with the rare-earth element includes a silicon nitride (SiN) waveguide. In yet other embodiments, the modulator is selected from a list of modulators consisting of (i) a Mach-Zehnder modulator, (ii) an electro-absorption modulator, and (iii) a micro-ring modulator.

In some embodiments, the circuit further includes a waveguide coupler configured to optically couple the silicon waveguide to the waveguide doped with the rare-earth element, and the waveguide doped with the rare-earth element is configured to amplify the modulated optical signal. In other embodiments, the circuit further includes: (i) a polarization splitter rotator configured to separate an incoming optical signal into polarization components, and (ii) an optical hybrid configured to mix the incoming optical signal with a local oscillator signal to form a mixed incoming optical signal for coherent detection, and the circuit is configured as a receiver or a transceiver. In yet other embodiments, the circuit further includes a germanium photodetector configured to convert the mixed optical signals from the optical hybrid to electrical signals.

In some embodiments, the photonic device further includes: (i) a fiber array unit configured to interface between optical fibers and the circuit, and (ii) a mode converter configured to expand a waveguide optical mode size to match an optical fiber mode size. In other embodiments, the circuit further includes a splitter configured to divide pump power from the laser into multiple paths, each of the multiple paths configured to feed into a respective WDM coupler. In yet other embodiments, the circuit further includes a polarization rotator combiner configured to combine amplified signals from the waveguide doped with the rare-earth element into a transmitter output.

There is additionally provided, in accordance with an embodiment of the present invention, a method of fabricating a photonic device with an integrated waveguide amplifier, the method including forming, on a substrate of a circuit, a first waveguide for conveying an optical signal. A second waveguide is formed on the substrate of the circuit, and rare-earth elements are implanted into the second waveguide to form the waveguide amplifier. The first waveguide is optically coupled to a first light source emitting the optical signal, and the second waveguide is optically coupled to a second light source emitting a second light for optically exciting the rare-earth elements to provide optical gain to the optical signal.

In some embodiments, optically coupling to the first light source includes optically coupling the first waveguide to a continuous wave (CW) laser, and optically coupling to the second light source includes optically coupling the second waveguide to a laser to emit the second light for the optical excitation.

There is further provided, in accordance with an embodiment of the present invention, a circuit, including (i) a substrate, (ii) a modulator formed on the substrate and configured to receive an optical signal and to generate a modulated optical signal, (iii) a waveguide formed on the substrate and doped with a rare-earth element, the waveguide configured to amplify the modulated optical signal, and (iv) a wavelength division multiplexer (WDM) coupler formed on the substrate and configured to convey light from a laser into the waveguide, and in response to receiving the light from the laser, the waveguide is configured to optically excite the rare-earth element to provide optical gain for amplifying the modulated optical signal.

In some embodiments, the substrate includes silicon, the circuit further includes an additional waveguide formed on the substrate and configured to convey the optical signal to the modulator, and the waveguide includes a silicon nitride (SiN) waveguide. In other embodiments, the circuit further includes a polarization rotator combiner formed on the substrate and configured to combine amplified signals from the waveguide into a transmitter output, the circuit is configured as a transmitter or a transceiver. In yet other embodiments, the circuit further includes: (i) a polarization splitter rotator, formed on the substrate and configured to separate an incoming optical signal into polarization components, (ii) an optical hybrid, formed on the substrate and configured to mix the incoming optical signal with a local oscillator signal for coherent detection, and (iii) a photodetector formed on the substrate and configured to convert optical signals to electrical signals, the circuit is configured as a receiver or a transceiver.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a photonic device with an integrated waveguide amplifier and a sectional view of some components thereof, in accordance with an embodiment that is described herein;

FIG. 2 is a block diagram that schematically illustrates interfaces in the photonic device of FIG. 1, in accordance with an embodiment that is described herein;

FIG. 3 is a block diagram that schematically illustrates a photonic device configured as an Intensity Modulation with Direct Detection (IMDD) Coarse Wavelength Division Multiplexing 4 (CWDM4) transceiver with waveguide amplifiers, in accordance with another embodiment that is described herein;

FIG. 4 is a block diagram that schematically illustrates a photonic device configured as an Intensity Modulation with Direct Detection (IMDD) transceiver with waveguide amplifiers, in accordance with another embodiment that is described herein; and

FIG. 5 is flowchart that schematically illustrates a method of fabricating a photonic device with an integrated waveguide amplifier, in accordance with an embodiment that is described herein.

### DETAILED DESCRIPTION OF EMBODIMENTS

### Overview

Silicon photonics (SiPho) has emerged as a key integration platform for photonic integrated circuits (PICs) used in optical transceivers due to its ability to enable high-volume and cost-effective production through large (e.g., 200 mm and 300 mm) wafer processing, as well as its capability to integrate both transmitter and receiver functionality onto a single chip. However, one drawback of silicon photonics compared to III-V (InP) based PICs is the lack of simple integration of gain material in the platform to compensate for optical loss or to amplify signals.

Conventional approaches to providing optical amplification in silicon photonics transceivers present significant challenges. External amplifiers or semiconductor optical amplifiers (SOAs) are commonly used for amplification, but these approaches require additional expensive components and complex module assembly processes. Furthermore, external amplification introduces additional fiber coupling loss, typically in the range of 1-3 dB, which degrades transmitter launch optical signal-to-noise ratio (OSNR). Alternatively, III-V SOAs can be integrated onto silicon photonics platforms through hybrid integration techniques. However, this approach requires additional complicated processing steps and III-V SOA materials to be attached to the silicon photonics chip, and still suffers from coupling losses that degrade transmitter OSNR.

Embodiments that are described herein address these challenges by providing monolithic integration of waveguide amplifiers into silicon photonics transceiver chips in a manner that naturally fits standard fabrication processes of silicon photonics. In some embodiments, a rare-earth-doped silicon nitride (SiN) waveguide amplifier is integrated within the transceiver, where rare-earth ions, also referred to herein as rare-earth elements, such as but not limited to erbium or praseodymium are implanted into a low-loss SiN waveguide and subsequently annealed for activation. In an example implementation, an external pump laser operating at 980 nm or 1480 nm is coupled to the silicon photonics chip through a fiber array unit, and configured to convey pump light into the rare-earth-doped SiN waveguide through a wavelength division multiplexer (WDM) coupler.

In some embodiments, the modulated signal from a Mach-Zehnder modulator is amplified while traveling through the rare-earth-doped waveguide and then polarization-multiplexed in a polarization rotator combiner for transmission output. Additionally, or alternatively, the rare-earth-doped waveguide amplifier may be used together with any other suitable type of modulator, such as but not limited to an electro-absorption modulator, and a micro-ring modulator.

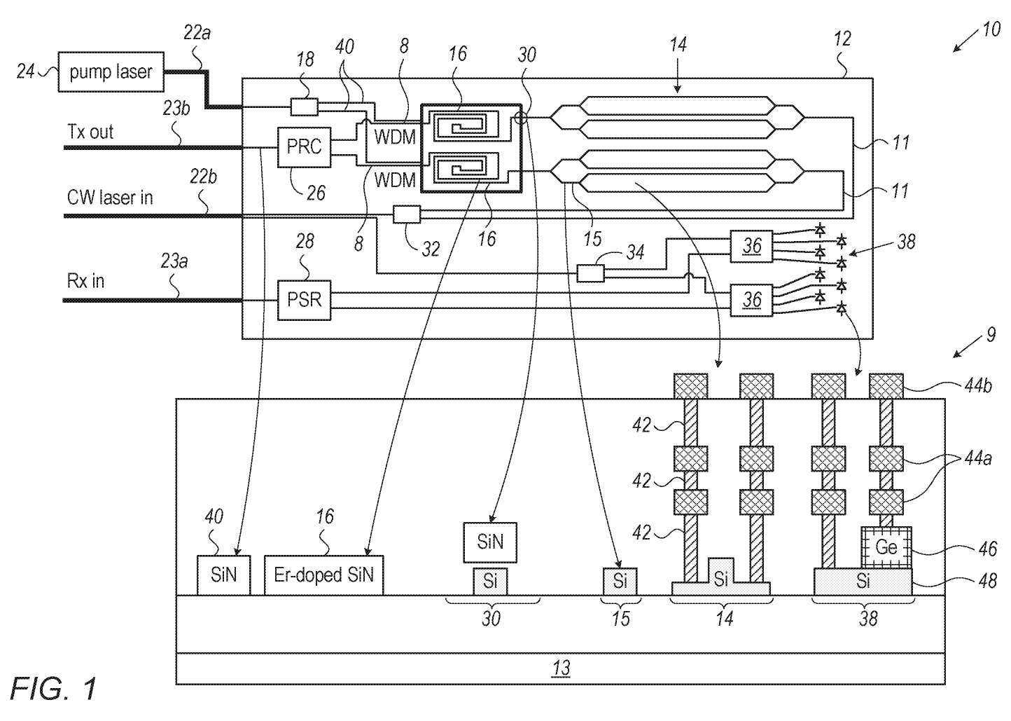

In some embodiments, the amplifier, which comprises the rare-earth-doped SiN waveguide, may be implemented in the transceiver: (a) on a transmitter side, (b) on a receiver side, and (c) on both transmitter and receiver sides, depending on the application and the device and/or the system architecture. In all the above configurations, the waveguide amplifier is accompanied by a laser, such as the pump laser, configured to convey pump light into the rare-earth-doped SiN waveguide through a WDM coupler as described above. For example, if the rare-earth-doped SiN waveguides are implemented on both transmitter and receiver sides, the transmitter and receiver sides receive the pump light from one or more respective laser sources. Non-limiting example implementations and configurations of these techniques are depicted in FIGS. 1-4 below.

The disclosed techniques advantageously eliminate the high-loss optical coupling associated with external amplifiers or on-chip hybrid SOAs. Since the coupling loss from the modulator output waveguide to the integrated waveguide amplifier is negligible, transmitter launch OSNR improvement over external amplifiers and SOAs configurations may be realized. Additionally, the fabrication process for the rare-earth-doped waveguide amplifier naturally fits within existing silicon photonics foundry processes, as the ion implantation and annealing steps can be incorporated without requiring complex hybrid integration of III-V semiconductor materials.

The description above is presented as a general overview of embodiments of the present disclosure, which are described in detail herein.

### Definitions

In the present context, the term "photonic device" may refer to an apparatus that at least one of processes, transmits, and receives optical signals, and may comprise components such as waveguides, modulators, photodetectors, and optical amplifiers integrated on a common substrate. For example, a photonic device may comprise a silicon photonics transceiver chip that integrates both transmitter and receiver functionality.

In the present context, the term "circuit" may refer to an integrated arrangement of optical and/or electrical components formed on a common substrate, configured to perform one or more of transmitting, receiving, and processing optical signals. A circuit may be configured as a transmitter for generating and outputting modulated optical signals, as a receiver for receiving and detecting incoming optical signals, or as a transceiver that combines both transmitter and receiver functionality. For example, a circuit may comprise waveguides, modulators, photodetectors, and waveguide amplifiers monolithically integrated on a silicon substrate.

In the present context, the term "pump laser" may refer to a light source configured to emit light at a specific wavelength for optically exciting a gain medium to achieve optical amplification. For example, a pump laser may operate at 980 nm or 1480 nm to excite erbium ions in a waveguide amplifier.

In the present context, the term "transceiver" may refer to an integrated optical component that combines both transmitter and receiver functionality on a single substrate, enabling bidirectional optical communication. For example, a transceiver may comprise modulators for generating modulated optical signals and photodetectors for converting received optical signals to electrical signals.

In the present context, the term "monolithically integrated" may refer to components that are fabricated together on a single substrate using a unified manufacturing process, rather than being separately manufactured and subsequently assembled. For example, a waveguide amplifier may be monolithically integrated with a modulator on a silicon substrate.

In the present context, the term "waveguide" may refer to a structure configured to confine and guide light and/or optical signals along a defined path on a substrate. For example, a waveguide may comprise silicon or silicon nitride (SiN) material formed on a silicon substrate.

In the present context, the terms "rare-earth element" and "rare-earth ions" are used interchangeably and may refer to a lanthanide series element that exhibits optical gain properties when optically excited, enabling signal amplification in optical waveguides. For example, a rare-earth element may comprise erbium for C-band (e.g., between about 1550 nm and 1625 nm) and L-band (e.g., between about 1530 nm and 1565 nm) amplification or praseodymium for O-band (e.g., between about 1260 nm and 1360 nm) amplification.

In the present context, the term "waveguide amplifier" may refer to an optical amplifier formed by doping a waveguide with a gain medium, such as rare-earth ions, to provide optical gain to signals propagating through the waveguide. For example, a waveguide amplifier may comprise an erbium-doped silicon nitride waveguide configured to amplify modulated optical signals.

In the present context, the term "wavelength division multiplexer (WDM) coupler" may refer to a passive optical device configured to combine or separate optical signals of different wavelengths into or from a single waveguide. For example, a WDM coupler may combine pump light at 980 nm with signal light at 1550 nm into a common waveguide path.

In the present context, the term "optical gain" may refer to the amplification of an optical signal's power as it propagates through a gain medium that has been optically excited. For example, optical gain may be provided by excited erbium ions in a doped waveguide when pump light excites the ions to a higher energy state.

In the present context, the term "modulator" may refer to an optical component configured to encode information onto an optical carrier signal by varying one or more properties of the light, such as amplitude, phase, or polarization. For example, a modulator may comprise a Mach-Zehnder modulator (MZM) that modulates a continuous wave laser input.

In the present context, the term "Mach-Zehnder modulator" or "MZM" may refer to an interferometric optical modulator configured to split an input optical signal into two paths, apply a phase difference between the paths, and recombine the signals to produce amplitude modulation. For example, a Mach-Zehnder modulator may modulate a continuous wave laser signal with data for transmission.

In the present context, the term "waveguide coupler" may refer to an optical component configured to transfer optical power between two or more waveguides through evanescent field coupling or other coupling mechanisms. For example, a waveguide coupler may optically couple a silicon waveguide to a silicon nitride waveguide.

In the present context, the term "polarization splitter rotator" or "PSR" may refer to an optical component configured to separate an incoming optical signal into its constituent polarization components and rotate one polarization state to align with the other. For example, a polarization splitter rotator may separate a received signal into transverse electric (TE) and transverse magnetic (TM) components for coherent detection.

In the present context, the term "optical hybrid" may refer to an optical component configured to mix an incoming signal with a local oscillator reference signal to generate multiple outputs, enabling the extraction of amplitude, phase, and polarization information in coherent detection systems. For example, an optical hybrid may produce in-phase and quadrature outputs for coherent receiver processing.

In the present context, the term "coherent detection" may refer to a detection technique that recovers both amplitude and phase information from an optical signal by mixing the signal with a local oscillator reference. For example, coherent detection may be implemented using an optical hybrid and balanced photodetectors.

In the present context, the term "photodetector" may refer to an optoelectronic component configured to convert optical signals to electrical signals through the photoelectric effect. For example, a photodetector may comprise a germanium-based photodetector (also referred to herein as a germanium photodetector) comprising a germanium structure formed on a silicon structure and/or on a silicon substrate.

In the present context, the term "fiber array unit" or "FAU" may refer to an assembly configured to interface multiple optical fibers with a photonic integrated circuit, providing organized optical connections between external fibers and on-chip waveguides. For example, a fiber array unit may comprise connections for a pump laser fiber, a transmitter output fiber, and a receiver input fiber.

In the present context, the term "mode converter" may refer to a passive optical device configured to expand or contract a waveguide optical mode size to match the mode size of another optical component, thereby reducing coupling loss. For example, a mode converter may expand a waveguide mode from approximately 1 micrometer to approximately 10 micrometers to match an optical fiber mode size.

In the present context, the term "splitter" may refer to an optical component configured to divide optical power from a single input into multiple output paths. For example, a 1x2 splitter may divide pump laser power equally into two paths for feeding separate waveguide amplifier sections.

In the present context, the term "polarization rotator combiner" or "PRC" may refer to an optical component configured to combine optical signals from different polarization states into a single output by rotating one polarization to be orthogonal to the other. For example, a polarization rotator combiner may combine amplified signals from two modulator paths into a polarization-multiplexed transmitter output.

In the present context, the term "substrate" may refer to a base material upon which photonic components are fabricated, providing mechanical support and serving as a foundation for waveguide and device formation. For example, a substrate may comprise silicon in a silicon photonics platform.

In the present context, the term "continuous wave laser" or "CW laser" may refer to a laser that emits a constant, un-modulated optical output, providing a carrier signal for subsequent modulation. For example, a continuous wave laser may provide input light to a Mach-Zehnder modulator for data encoding.

In the present context, the term "local oscillator" may refer to a reference optical signal used in coherent detection systems to mix with a received signal for extracting phase and amplitude information. For example, a local oscillator signal may be derived from a tunable laser and mixed with a received signal in an optical hybrid.

### System Description

FIG. 1 is a block diagram that schematically illustrates a photonic device 10 with an integrated waveguide amplifier and an inset 9 showing a sectional view of some components thereof, in accordance with an embodiment that is described herein.

In some embodiments, photonic device 10 comprises a transceiver 12 monolithically integrated on a substrate 13. In the present example, substrate 13 comprises (i) a silicon substrate, also referred to herein as a silicon wafer, or (ii) a silicon on insulator (SOI) substrate, also referred to herein as an SOI wafer. Both types of substrates are used in very large scale integration (VLSI) fabrication processes for various types of semiconductor devices. Transceiver 12 integrates both transmitter and receiver functionality on a single chip formed on substrate 13. In other embodiments, the circuit formed on substrate 13 may be configured as a transmitter only or as a receiver only, depending on the application and the device or system architecture. Moreover, transceiver 12 is optically coupled to a pump laser 24, also referred to herein as a laser, for brevity, which is configured to emit a laser beam, also referred to herein as a pump light or pump power, operating at a wavelength of about 980 nm or about 1480 nm or any other suitable wavelength. Pump laser 24 is configured to be optically connected to transceiver 12 via a polarization maintaining fiber (PMF) 22a. PMF 22a is configured to maintain Transverse Electric (TE) polarization of the pump light as the pump light travels from pump laser 24 into transceiver 12.

In some embodiments, photonic device 10 further comprises a PMF 22b configured to convey an optical signal implemented as a Continuous Wave (CW) laser input to transceiver 12. Transceiver 12 comprises a transmitter (Tx) output connected to a single mode fiber (SMF) 23b and a receiver (Rx) input connected to a SMF 23a. The CW laser input provides a carrier signal that is split between a transmitter path for modulation and a receiver path where the CW laser input serves as a local oscillator for coherent detection.

In some embodiments, within transceiver 12, The pump light emitted from pump laser 24 passes through a 1x2 splitter 18, which is configured to divide pump power from pump laser 24 into two paths. Each of the two paths feeds into a respective Wavelength Division Multiplexer (WDM) coupler 8. The WDM couplers 8 are configured to combine the aforementioned pump light (at 980 nm or 1480 nm) with signal light into a shared (i.e., common) waveguide path. The WDM couplers 8 are configured to convey the pump light into an Er-doped SiN waveguide 16. Er-doped SiN waveguide 16 comprises a Silicon Nitride (SiN) waveguide doped with a rare-earth element, such as but not limited to erbium ions and forms a waveguide amplifier. An Er-doped SiN area 20 defines a region where erbium ions are implanted into the silicon nitride waveguide structure, as described in more detail below. In the present example, Er-doped SiN waveguide 16 is configured to provide optical amplification in C-band and L-band wavelengths.

In some embodiments, transceiver 12 comprises multiple modulators 14. In the present example, modulators 14 comprise Mach-Zehnder Modulators (MZM) configured to modulate the CW laser input with data for transmission. Each modulator 14 splits an input optical signal into two paths, applies a phase difference between the two paths, and recombines the signals to produce amplitude modulation. The modulated signals from modulators 14 travel through silicon (Si) waveguides 15. A Si-to-SiN waveguide transition 30 is configured to enable coupling between one or more silicon waveguide 15 and the one or more Er-doped silicon nitride waveguides 16. In some embodiments, each Er-doped SiN waveguide 16 is configured to amplify the modulated signals as the modulated signals pass through Er-doped SiN waveguide 16. More specifically, in response to receiving light emitted from pump laser 24, Er-doped SiN waveguide 16 is configured to optically excite the erbium ions to provide optical gain to the modulated optical signals conveyed through transceiver 12.

In some embodiments, transceiver 12 further comprises a Polarization Rotator Combiner (PRC) 26. PRC 26 combines amplified signals from different modulator outputs into a single transmitter output. PRC 26 is configured to rotate one polarization by 90 degrees so that two independent polarization states are realized within the optical fiber at the Tx output. The amplified and polarization-multiplexed signal exits transceiver 12 through SMF 23b. In embodiments in which the circuit is configured as a transmitter or a transceiver, PRC 26 provides the transmitter output functionality.

In some embodiments, a Polarization Splitter Rotator (PSR) 28 is configured to separate incoming optical signals into constituent polarization components. PSR 28 is configured to separate a received signal into Transverse Electric (TE) and Transverse Magnetic (TM) components for coherent detection. Transceiver 12 comprises a 1x2 splitter 32 configured to split the CW laser input into two paths to feed two respective groups of modulators 14. The receiver path further comprises a 1x2 splitter 34 configured to split the local oscillator signal into two paths to feed both of the optical hybrid 36 components. Optical hybrid 36 is configured to mix incoming signals with a local oscillator reference signal derived from the CW laser input to generate multiple outputs, enabling extraction of amplitude, phase, and polarization information in coherent detection systems. In embodiments in which the circuit is configured as a receiver or a transceiver, PSR 28 and optical hybrid 36 provide the receiver functionality for coherent detection of incoming optical signals.

In some embodiments, transceiver 12 comprises multiple germanium-based photodetectors, referred to herein as Ge photodetectors 38. Ge photodetectors 38 are configured to convert mixed optical signals from optical hybrid 36 to electrical signals. Transceiver 12 further comprises multiple waveguides 11 and a SiN waveguide 40 that provide routing paths throughout photonic device 10. In some embodiments, waveguides 11 comprise SiN waveguides or silicon waveguides.

Reference is now made to an inset 9 showing a schematic sectional view of selected components of photonic device 10. In some embodiments, SiN waveguide 40, Er-doped SiN waveguide 16, and a silicon waveguide structure 48 are formed on substrate 13. In some embodiments, a germanium structure 46, which forms Ge photodetector 38, is formed, e.g., epitaxially grown, on silicon waveguide structure 48 to enable efficient optical-to-electrical conversion for receiver functionality. Transceiver 12 further comprises metal interconnects, in the present example, traces of metal layers 44a, via structures 42 and traces of a top metal 44b, to provide electrical connections. In some embodiments, via structures 42 are configured to connect between different levels of the metal layers 44, and between metal layers 44 and the active device regions, such as modulator 14 and Ge photodetector 38.

In some embodiments, Er-doped SiN waveguide 16 comprises a width in a range between about 0.5 μm and about 2.0 μm, a thickness in a range between about 0.2 μm and about 0.5 μm, and a length in a range between about 5 cm and about 30 cm. The length of Er-doped SiN waveguide 16 provides sufficient interaction length for optical amplification of signals propagating through Er-doped SiN waveguide 16.

In some embodiments, transceiver 12 comprises one or more un-doped SiN waveguides, such as waveguide 11 (that may comprise SiN or Si as described above) and SiN waveguide 40, that provide routing paths throughout photonic device 10. Waveguide 11 and SiN waveguide 40 are configured to guide optical signals between components within transceiver 12. In some embodiments, waveguide 11 and SiN waveguide 40 comprise a width in a range between about 0.5 μm and about 1.2 μm and a thickness in a range between about 0.2 μm and about 0.5 μm. The thickness of waveguide 11 and SiN waveguide 40 may be similar to the thickness of Er-doped SiN waveguide 16.

In some embodiments, transceiver 12 comprises a tapered waveguide structure configured to provide a width transition between un-doped waveguides and Er-doped SiN waveguide 16. The tapered waveguide structure gradually changes the waveguide width to reduce optical loss at the interface between un-doped and Er-doped waveguide regions.

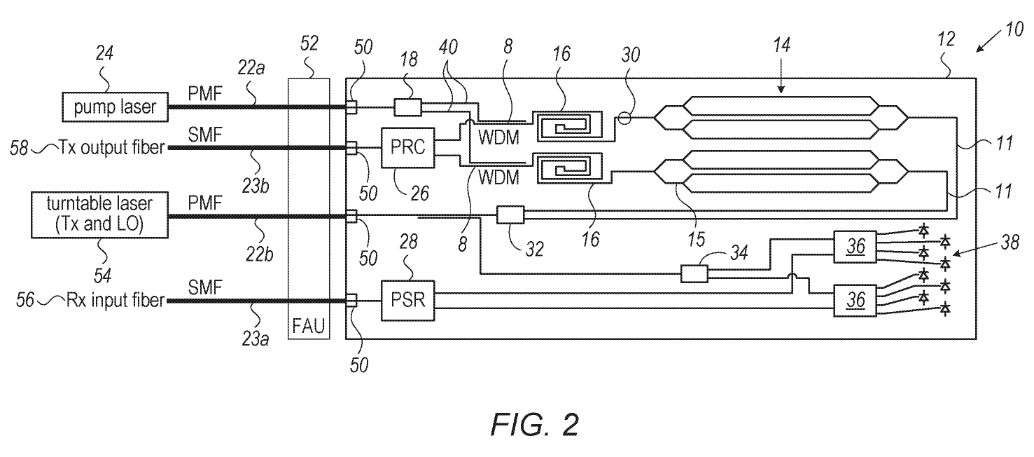

FIG. 2 is a block diagram that schematically illustrates interfaces in photonic device 10, in accordance with an embodiment that is described herein. Photonic device 10 comprises a fiber array unit 52 positioned at an interface between external optical fibers and transceiver 12. Fiber array unit 52 receives multiple fiber connections comprising PMF 22a, PMF 22b, SMF 23a, and SMF 23b. Pump laser 24 is connected to fiber array unit 52 via PMF 22a. A tunable laser 54, which serves as both the transmitter laser and local oscillator, is connected via PMF 22b. A Tx output fiber 58 is connected via SMF 23b, and an Rx input fiber 56 is connected via single mode fiber 23a.

In some embodiments, a mode converter 50 is positioned between fiber array unit 52 and interfacing with some components of transceiver 12. Mode converter 50 is configured to expand a waveguide optical mode size e.g., from approximately 1 μm by 1 μm, to match an optical fiber mode size, e.g., of approximately 10 μm by 10 μm, thereby reducing coupling loss between the optical fibers and transceiver 12. In some embodiments, transceiver 12 comprises an additional waveguide, such as silicon waveguide 15, formed on substrate 13 and configured to convey the optical signal to modulator 14.

In some embodiments, 1x2 splitter 18 is configured to receive pump light from pump laser 24 and to divide pump power into two paths. In an embodiment, 1x2 splitter 18 may comprise a Multi-Mode Interferometer (MMI) or a Directional Coupler (DC). Each of the two paths from 1x2 splitter 18 feeds into a respective wavelength division multiplexer (WDM) coupler 8. WDM coupler 8 comprises a passive optical device configured to combine pump light from pump laser 24 with signal light into a common waveguide path. In some embodiments, WDM coupler 8 may comprise a side-wall grating coupler, a Two-Mode Interferometer (TMI), or a Directional Coupler (DC).

In some embodiments, WDM coupler 8 is configured to convey pump light from pump laser 24 into Er-doped SiN waveguide 16, which is configured to amplify the modulated optical signals as described in more detail in FIG. 1 above.

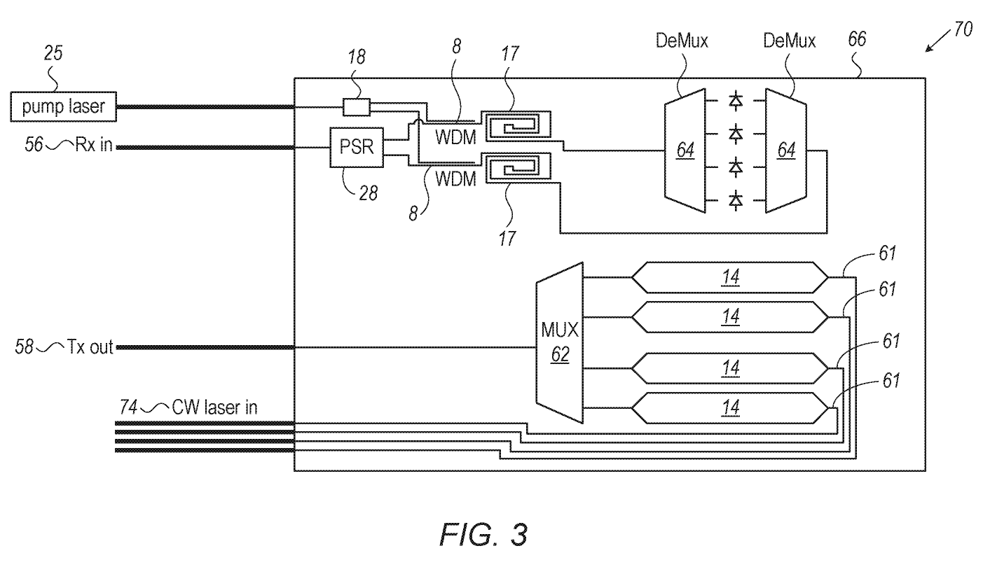

FIG. 3 is a block diagram that schematically illustrates a photonic device 70 configured as an Intensity Modulation with Direct Detection (IMDD) Coarse Wavelength Division Multiplexing 4 (CWDM4) transceiver with waveguide amplifiers, in accordance with another embodiment that is described herein. Unlike photonic device 10 described above, which uses an Er-doped SiN waveguide 16 for C-band and L-band amplification, photonic device 70 comprises a transceiver 66 that uses SiN waveguides with other rare-earth dopants. In the present example, Praseodymium (Pr)-doped SiN waveguides 17 are used for O-band wavelength amplification, e.g., at wavelengths of about 1310 nm.

In some embodiments, on a receiver side of transceiver 66, an Rx input fiber 56 is connected to a Polarization Splitter Rotator (PSR), such as PSR 28 described in FIG. 1 above, which separates an incoming signal into two polarization components. The separated polarization components are directed through respective WDM couplers 8. A pump laser 25 is configured to provide pump light that is coupled into transceiver 66 and split to feed Pr-doped SiN waveguides 17 through WDM couplers 8. Notably, the pump laser and SiN waveguides receive different numerals than that of FIG. 1 above for being used in generating and amplifying different wavelengths, but the functionality of these components is similar in devices 10 and 70. Pr-doped SiN waveguides 17 are configured to amplify the received optical signals in the O-band wavelength range. After amplification, the signals pass through wavelength demultiplexers (DeMux) 64, which are configured to separate the different wavelength channels for detection by respective photodiodes. In some embodiments, the photodiodes comprise Ge photodetectors 38 or any other suitable type of photodetector.

In some embodiments, on a transmitter side of transceiver 66, a CW laser input 74 provides continuous wave laser light at multiple wavelengths. The CW laser light is distributed through waveguides 61, with each of waveguides 61 configured to guide a specific wavelength of the laser beam. Waveguides 61 connect to respective Mach-Zehnder modulators 14 configured to modulate the optical signals with data. The modulated signals from modulators 14 are combined by a wavelength division multiplexer (Mux) 62, which is configured to combine the multiple wavelength channels into a single output. The combined signal exits transceiver 66 through a Tx output fiber 58.

In some embodiments, unlike photonic device 10 in which the waveguide amplifiers are positioned in the transmitter path, photonic device 70 positions Pr-doped SiN waveguides 17 in the receiver path for signal amplification. This configuration enables signal amplification for O-band CWDM4 applications without requiring external amplifier modules.

In alternative embodiments, transceiver 66 may be configured with the waveguide amplifier on the transmitter side only, without a waveguide amplifier on the receiver side. In such embodiments, on the transmitter side, CW laser input 74 provides continuous wave laser light at multiple wavelengths to respective modulators via waveguides 61. The modulators may comprise electro-absorption modulators (EAMs) or Mach-Zehnder modulators (MZMs) or any other suitable type of modulators. In some embodiments, transceiver 66 comprises 4, 8, 16, or any other suitable number of modulators. The modulated signals from the modulators are wavelength-multiplexed by Mux 62, and the wavelength-multiplexed signal is then amplified collectively in Pr-doped SiN waveguides 17. Pump laser 25 provides pump light that is coupled into Pr-doped SiN waveguides 17 through WDM coupler 8. The amplified signal exits transceiver 66 through Tx output fiber 58. On the receiver side, Rx input fiber 56 is connected to PSR 28, which separates an incoming optical signal into polarization components. The separated polarization components are directed through wavelength demultiplexers (DeMux) 64 for wavelength demultiplexing and detection by respective photodetectors, without waveguide amplification on the receiver side.

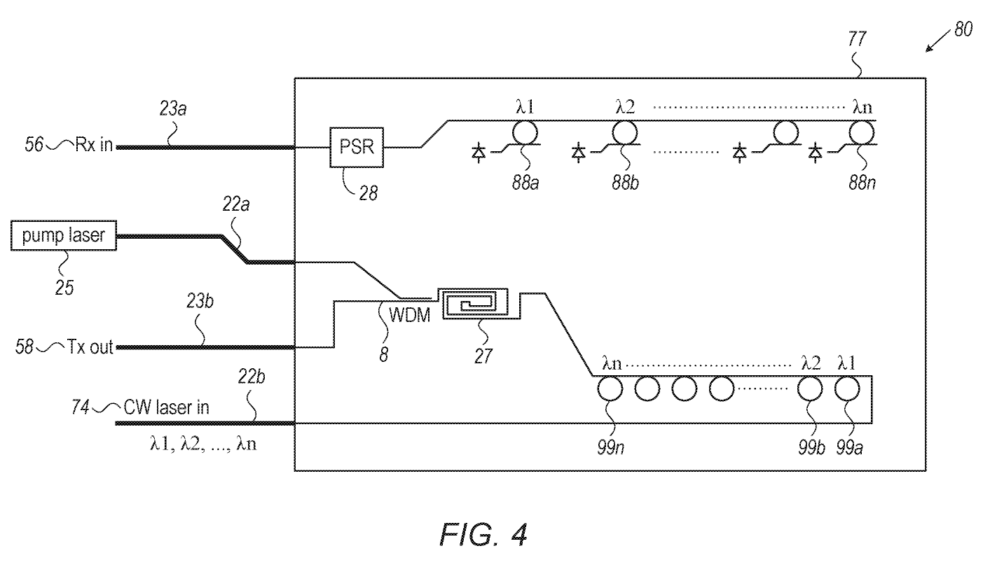

FIG. 4 a block diagram that schematically illustrates a photonic device 80 configured as an IMDD transceiver 77 with one or more waveguide amplifiers 27, in accordance with another embodiment that is described herein. Unlike photonic device 10 described above, which uses Mach-Zehnder modulators 14, photonic device 80 comprises a transceiver 77 that uses micro-ring modulators (MRMs) on the transmitter side and micro-ring resonators (MRRs) on the receiver side.

In some embodiments, on a transmitter side of transceiver 77, a CW laser input 74 provides continuous wave laser light at multiple wavelengths via PMF 22b. The CW laser light is distributed through a bus waveguide to multiple micro-ring modulators comprising MRM 99a, MRM 99b, through the n-th MRM referred to herein as a MRM 99n. The MRMs 99 are arranged in series on the bus waveguide. Each micro-ring modulator is configured to pick continuous wave light at a resonant wavelength and modulate the light. For example, MRM 99a is configured to modulate wavelength at 1308 nm, MRM 99b is configured to modulate wavelength at 1310 nm, and MRM 99n is configured to modulate wavelength at 1312 nm. In some embodiments, transceiver 77 comprises any number of micro-ring modulators, such as 4, 8, 16, or any other suitable number. In the present example, these micro-ring modulators 99a-99n are arranged in series on the bus waveguide.

In some embodiments, a rare-earth doped SiN waveguide 27 is positioned in series with (e.g., after) the micro-ring modulators on the transmitter side. In the present example, SiN waveguide 27 may be doped with any suitable type of rare-earth ions, such as but not limited to praseodymium. Notably, the doped SiN waveguide receives a different numeral than that of FIG. 3 above for being used in another configuration, but the functionality (and optionally the configuration) of these components is typically similar in devices 70 and 80. This configuration is advantageous because micro-ring modulators, such as MRMs 99 tend to suffer from thermal and non-linear effects under high (or excess) laser input power. By operating the micro-ring modulators at reduced laser power and amplifying the modulated signals collectively in rare-earth doped SiN waveguide 27 after modulation, the thermal and non-linear effects on the micro-ring modulators are reduced. Pump laser 25 is connected to transceiver 77 via PMF 22a and is configured to provide pump light that is coupled into rare-earth doped SiN waveguide 27 through WDM coupler 8. The modulated and amplified signals are combined through WDM coupler 8 and exit transceiver 77 through a Tx output fiber 58 via SMF 23b.

In some embodiments, on the receiver side of transceiver 77, an Rx input fiber 56 is connected to PSR 28 via SMF 23a. PSR 28 is configured to separate an incoming optical signal into polarization components. The separated polarization components are directed through rare-earth doped SiN waveguide 27, which is configured to amplify the received optical signals. Pump laser 25 provides pump light that is coupled into rare-earth doped SiN waveguide 27 through WDM coupler 8. The amplified signals from rare-earth doped SiN waveguide 27 are directed to multiple micro-ring resonators comprising MRR 88a, MRR 88b, through MRR 88n corresponding to MRM 99a, MRM 99b, and MRM 99n, respectivly. Each of these micro-ring resonators is configured as an optical filter device that picks modulated light at a resonant wavelength in the ranges of wavelength described above, and couples the light into a corresponding photodetector for wavelength demultiplexing and detection. For example, MRR 88a is configured to detect wavelength(s) at the above range of the red light, MRR 88b is configured to detect wavelength(s) at the above range of the green light, and MRR 88n is configured to detect wavelength(s) at the above range of the purple light.

In other embodiments, photonic device 80 may have a different configuration in which rare-earth doped SiN waveguide 27 is positioned on both the transmitter side and the receiver side of transceiver 77, as described in the overview section above. This dual-side amplification configuration is designed to provide optical gain for both transmitted and received signals within a single transceiver.

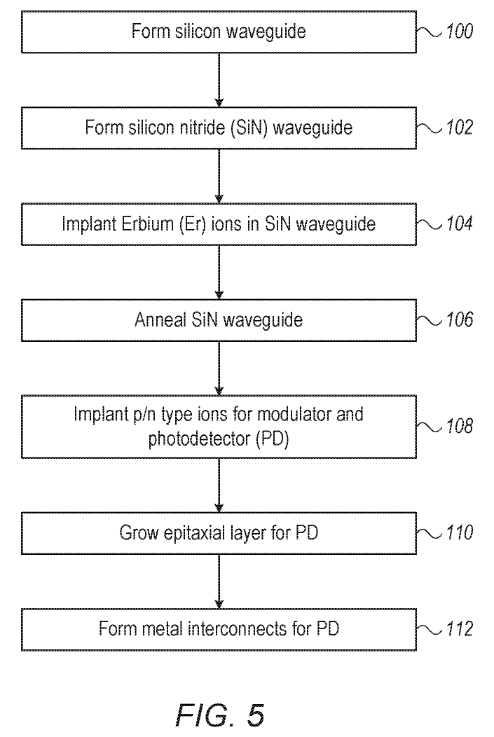

FIG. 5 is a flowchart that schematically illustrates a method of fabricating photonic device 10 with integrated waveguide amplifier 16, in accordance with an embodiment that is described herein. In the present example, the method integrates rare-earth-doped Silicon Nitride (SiN) waveguide amplifier fabrication with standard silicon photonics foundry processes, enabling monolithic integration of waveguide amplifiers into silicon photonics transceiver chips, as described in FIG. 1 above. In other embodiments, the method may be applied, with necessary changes, to other sorts of photonic devices, such as photonic device 70 of FIG. 3 above.

At a stage 100, a first waveguide, in the present example silicon waveguide 15, is prepared on substrate 13 of transceiver 12. In some embodiments, stage 100 comprises photolithography and etching of a Silicon On Insulator (SOI) wafer to form silicon waveguide 15. Silicon waveguide 15 provides optical routing paths for conveying optical signals within transceiver 12. In some embodiments, the silicon waveguide formation at stage 100 defines waveguide structures for modulator 14 and other silicon-based optical components. In some embodiments, the first waveguide is optically coupled to a first light source, such as a continuous wave (CW) laser, that emits the optical signal.

At a stage 102, a second waveguide, in the present example a SiN waveguide, such as SiN waveguide 40, is prepared on substrate 13 of transceiver 12. In some embodiments, stage 102 comprises depositing SiN material on substrate 13, followed by photolithography and etching of the deposited SiN to form SiN waveguide 40, and optionally other SiN waveguide structures. SiN waveguide 40 provides low-loss routing paths throughout photonic device 10. In some embodiments, the SiN waveguide formed at stage 102 comprises a width in a range between about 0.5 μm and about 2.0 μm and a thickness in a range between about 0.2 μm and about 0.5 μm, as described above. In some embodiments, the second waveguide is optically coupled to a second light source, such as pump laser 24, that emits light for optically exciting the rare-earth ions (also referred to herein as rare-earth elements).

At a stage 104, rare-earth ions are implanted into the SiN waveguide to form a waveguide amplifier. In some embodiments, stage 104 comprises defining an Er-doped SiN area 20 by photolithography and implanting erbium ions into the defined region of the SiN waveguide. In alternative embodiments, stage 104 comprises implanting praseodymium ions into the SiN waveguide for O-band wavelength amplification applications, as described in FIG. 3 above. The ion implantation at stage 104 forms Er-doped SiN waveguide 16 or Pr-doped SiN waveguide 17, depending on the target wavelength band for amplification.

At a stage 106, the SiN waveguide is annealed to activate the implanted rare-earth ions. In some embodiments, stage 106 comprises thermal annealing of Er-doped SiN waveguide 16 to activate the implanted erbium ions and to reduce waveguide loss in the Er-doped SiN regions. The annealing at stage 106 enables the rare-earth ions to provide optical gain when optically excited by pump laser 24.

At a stage 108, p-type and n-type ions are implanted for modulator 14 and a photodetector for converting optical signals to electrical signals. In some embodiments, stage 108 comprises ion implantation to form doped regions in silicon waveguide structure 48 for modulator 14 and Ge photodetector 38. Stage 108 further comprises an ion activation anneal to activate the implanted p-type and n-type dopants.

At a stage 110, an epitaxial layer is grown for the photodetector. In some embodiments, stage 110 comprises epitaxially growing germanium structure 46 on silicon waveguide structure 48 to form Ge photodetector 38. Ge photodetector 38 converts optical signals from optical hybrid 36 to electrical signals for receiver functionality.

At a stage 112, metal interconnects are formed for the photodetector and modulator(s). In some embodiments, stage 112 comprises Back-End-Of-Line (BEOL) processing to form metal layers 44a, via structures 42, and top metal 44b. The metal interconnects provide electrical connections to modulator 14 and Ge photodetector 38. Via structures 42 connect between different levels of metal layers 44a, between metal layers 44a and 44b, and between metal layers 44a and active device regions.

In some embodiments, the fabrication method described in stages 100 through 112 enables monolithic integration of waveguide amplifiers into silicon photonics transceiver chips without requiring complex hybrid integration of III-V semiconductor materials. The ion implantation and annealing stages 104 and 106 naturally fit within existing silicon photonics foundry processes, as these stages can be incorporated into the standard wafer processing sequence.

Although the embodiments described herein mainly address waveguide-based amplifiers in optical transceivers, the methods and systems described herein can also be used in other applications.

This particular examples of configuration of photonic devices 10, 70 and 80 (depicted in FIGS. 1-4), and the steps of the method of FIG. 5 are shown by way of example, in order to illustrate certain problems that are addressed by embodiments of the present invention and to demonstrate the application of these embodiments in enhancing the performance of such silicon photonics (SiPho) devices. Embodiments of the present invention, however, are by no means limited to this specific sort of example photonic devices, and the principles described herein may similarly be applied to other sorts of photonic devices and other fabrication techniques thereof.

It is noted that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A photonic device, comprising:
a laser configured to emit light for optical excitation; and
a circuit, monolithically integrated on a substrate and optically coupled to the laser, the circuit comprising:
a waveguide doped with a rare-earth element, the waveguide configured to form a waveguide amplifier; and
a wavelength division multiplexer (WDM) coupler configured to convey light from the laser into the waveguide doped with the rare-earth element;
wherein, in response to receiving the light emitted from the laser, the waveguide is configured to optically excite the rare-earth element to provide optical gain to an optical signal conveyed into the circuit.

2. The photonic device according to claim 1, wherein the rare-earth element comprises erbium or praseodymium.

3. The photonic device according to claim 1, wherein the substrate comprises a silicon substrate, and the circuit further comprises a silicon waveguide and a modulator coupled to the silicon waveguide, the modulator being configured to modulate the optical signal from a continuous wave laser input to form a modulated optical signal, and wherein the waveguide doped with the rare-earth element comprises a silicon nitride (SiN) waveguide.

4. The photonic device according to claim 3, wherein the modulator is selected from a list of modulators consisting of (i) a Mach-Zehnder modulator, (ii) an electro-absorption modulator, and (iii) a micro-ring modulator.

5. The photonic device according to claim 3, wherein the circuit further comprises a waveguide coupler configured to optically couple the silicon waveguide to the waveguide doped with the rare-earth element, wherein the waveguide doped with the rare-earth element is configured to amplify the modulated optical signal.

6. The photonic device according to claim 1, wherein the circuit further comprises: (i) a polarization splitter rotator configured to separate an incoming optical signal into polarization components, and (ii) an optical hybrid configured to mix the incoming optical signal with a local oscillator signal to form a mixed incoming optical signal for coherent detection, wherein the circuit is configured as a receiver or a transceiver.

7. The photonic device according to claim 6, wherein the circuit further comprises a germanium photodetector configured to convert the mixed optical signals from the optical hybrid to electrical signals.

8. The photonic device according to claim 1, further comprising: (i) a fiber array unit configured to interface between optical fibers and the circuit, and (ii) a mode converter configured to expand a waveguide optical mode size to match an optical fiber mode size.

9. The photonic device according to claim 1, wherein the circuit further comprises a splitter configured to divide pump power from the laser into multiple paths, each of the multiple paths configured to feed into a respective WDM coupler.

10. The photonic device according to claim 1, wherein the circuit further comprises a polarization rotator combiner configured to combine amplified signals from the waveguide doped with the rare-earth element into a transmitter output.

11. A method of fabricating a photonic device with an integrated waveguide amplifier, the method comprising:
forming, on a substrate of a circuit, a first waveguide for conveying an optical signal;
forming, on the substrate of the circuit, a second waveguide and implanting rare-earth elements into the second waveguide to form the waveguide amplifier; and
optically coupling (i) the first waveguide to a first light source emitting the optical signal, and (ii) the second waveguide to a second light source emitting a second light for optically exciting the rare-earth elements to provide optical gain to the optical signal.

12. The method according to claim 11, wherein the substrate comprises silicon, forming the first waveguide comprises forming a silicon waveguide, and forming the second waveguide comprises forming a silicon nitride (SiN) waveguide

13. The method according to claim 11, wherein implanting the rare-earth elements comprises implanting erbium ions or praseodymium ions into the second waveguide.

14. The method according to claim 11, further comprising: (a) forming, on the substrate of the circuit, (i) a photodetector for detecting the optical signal, and (ii) a modulator for modulating the optical signal, and (b) forming metal interconnects for the modulator and the photodetector.

15. The method according to claim 11, wherein optically coupling to the first light source comprises optically coupling the first waveguide to a continuous wave (CW) laser, and optically coupling to the second light source comprises optically coupling the second waveguide to a laser to emit the second light for the optical excitation.

16. The method according to claim 11, further comprising optically coupling the second waveguide to a wavelength division multiplexer (WDM) coupler for conveying the second light from the second light source into the second waveguide.

17. A circuit, comprising:
a substrate;
a modulator formed on the substrate and configured to receive an optical signal and to generate a modulated optical signal;
a waveguide formed on the substrate and doped with a rare-earth element, the waveguide configured to amplify the modulated optical signal; and
a wavelength division multiplexer (WDM) coupler formed on the substrate and configured to convey light from a laser into the waveguide, wherein in response to receiving the light from the laser, the waveguide is configured to optically excite the rare-earth element to provide optical gain for amplifying the modulated optical signal.

18. The circuit according to claim 17, wherein the substrate comprises silicon, the circuit further comprising an additional waveguide formed on the substrate and configured to convey the optical signal to the modulator, and wherein the waveguide comprises a silicon nitride (SiN) waveguide.

19. The circuit according to claim 17, further comprising a polarization rotator combiner formed on the substrate and configured to combine amplified signals from the waveguide into a transmitter output, wherein the circuit is configured as a transmitter or a transceiver.

20. The circuit according to claim 17, further comprising: (i) a polarization splitter rotator, formed on the substrate and configured to separate an incoming optical signal into polarization components, (ii) an optical hybrid, formed on the substrate and configured to mix the incoming optical signal with a local oscillator signal for coherent detection, and (iii) a photodetector formed on the substrate and configured to convert optical signals to electrical signals, wherein the circuit is configured as a receiver or a transceiver.
